(19) United States
(12) Patent Application Publication
(10) Pub. No.: US 2011/0043336 A1
(43) Pub. Date: Feb. 24, 2011

(54) POWER EFFICIENCY OF THE LOAD-SHIFT KEYING TECHNIQUE

(75) Inventor: Svetoslav Radoslavov Gueorguiev, Aalborg (DK)

Correspondence Address: KNOBBE MARTENS OLSON & BEAR LLP, 2040 MAIN STREET, FOURTEENTH FLOOR, IRVINE, CA, 92614, US

(73) Assignee: AALBORG UNIVERSITET, Aalborg (DK)

(21) Appl. No.: 12/866,799

(22) PCT Filed: Feb. 17, 2009
(86) PCT No.: PCT/DK09/00041

§ 371 Date: Oct. 4, 2010

(30) Foreign Application Priority Data
Feb. 18, 2008 (EP) 08101714.7

(51) Int. Cl. H04Q 5/22

(52) U.S. Cl. 340/10.1

(57) ABSTRACT

The invention relates to a data transformer and a system for wireless transmission of energy and/or data and to a method for wireless transmission of energy and/or data from the primary side to the secondary side of the data transformer and/or vice versa: from the secondary to the primary side.

### FIELD AND BACKGROUND OF THE INVENTION

The invention relates to a data transformer and a system for wireless transmission of energy and/or data and to a method for wireless transmission of energy and/or data from the primary side to the secondary side of the data transformer and/or vice versa: from the secondary to the primary side.

Such data transformers are usually being used in bi-directional transmission systems designed for biological signal sensing. These systems comprise an external module and an implantable module.

The Load-Shift Keying (LSK) technique is commonly utilized in the data transformers for bi-directional transmission systems.

### OBJECTS AND SUMMARY OF THE INVENTION

The Load-Shift Keying (LSK) used in bi-directional transmission systems has however a few drawbacks.

Accordingly, the invention preferably seeks to mitigate, alleviate or eliminate singly or in any combination one or more of the drawbacks of the Load-Shift Keying (LSK) technique.

For example one of these drawbacks is that a lot of power is being lost in the implantable device and as a result in the whole system. One object of the present invention is to solve this problem.

Another object of the present invention is to improve the sensitivity of the data transformer and the whole system.

It is yet another object of the invention to improve the transmission capabilities of the data transformer and the whole system.

It is accordingly an object of the invention to provide a data transformer, a system and a method for wireless data and/or energy transmission.

The objects of the present invention are obtained by providing a data transformer, a system and a method for wireless transmission of energy and/or data from the primary to the secondary side and/or vice versa.

In another aspect, the invention relates to a computer program product being adapted to enable the system to perform and/or control the transmission or other of the system operations.

In yet another aspect, the invention relates to a computer program product being adapted to utilize the method for data and/or energy transmission in the data transformer and/or the system.

The main objects, aspects and/or features of the present invention are described below and/or set forth in the independent claims.

Further objects, aspects and/or features of the invention are described below and/or set forth in the dependent claims.

### BRIEF DESCRIPTION OF THE DRAWINGS

The present invention will now be explained, by way of example only, with reference to the accompanying drawings, where:

FIG. 1 shows the load-shift keying concept used for example in data transformers,

FIG. 2 shows a typical implementation of the load-shift keying technique or principle,

FIG. 3 illustrates a possible partitioning of the building blocks of the circuits on the secondary side of a data transformer according to the present invention,

FIG. 4 shows a first possible embodiment according to the present invention comprising a first power efficient architecture employing the Load-Shift Keying technique or principle,

FIG. 5 illustrates a second possible embodiment according to the present invention comprising a second power efficient architecture employing the Load-Shift Keying technique or principle,

FIG. 6 illustrates a third possible embodiment according to the present invention comprising a third power efficient architecture employing the Load-Shift Keying technique or principle,

FIG. 7 illustrates an ideal AC voltage source connected in series with a capacitor, an inductor and a load resistor R_{L},

FIG. 8 illustrates an ideal AC voltage source connected in series with an inductor, wherein a capacitor C₁ is connected in parallel to the already formed series network. A load resistor R_{L} is connected in parallel to the capacitor C₁.

FIG. 9 shows an equivalent model of a transformer with a capacitor C₁ resonating with the inductance of the primary coil L₁ and a capacitor C₂ resonating with the inductance of the secondary coil L₂,

FIG. 10 illustrates a fourth possible embodiment according to the present invention, which is a further development of the circuit shown in FIG. 5, and

FIG. 11 illustrates a fifth possible embodiment according to the present invention in the case of far-field communication.

### DETAILED DESCRIPTION OF THE INVENTION

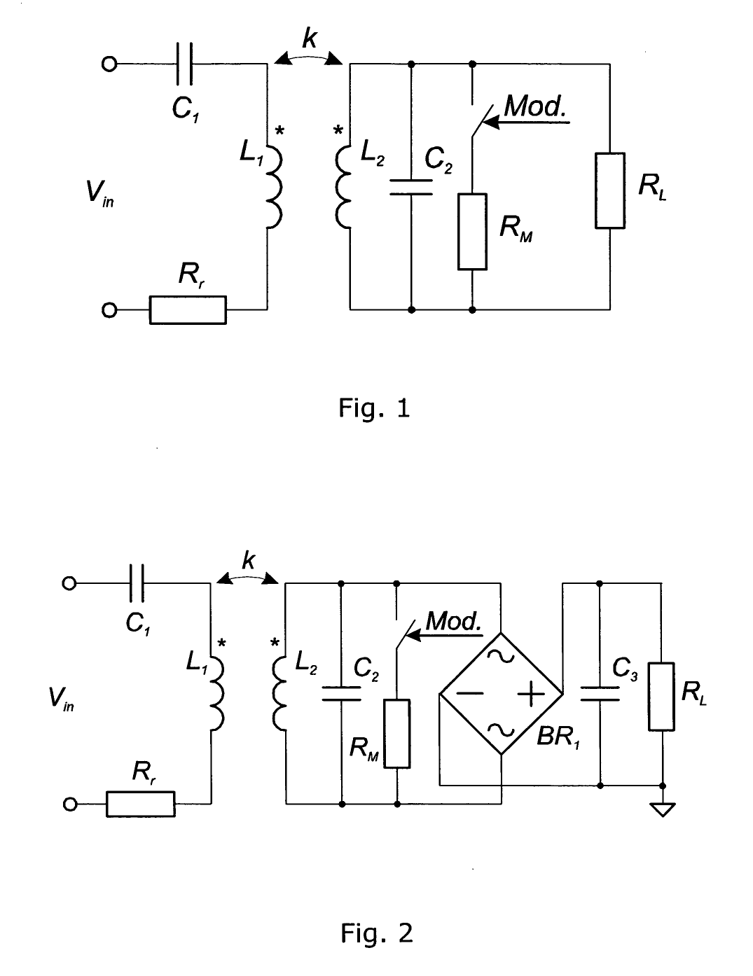

The Load-Shift Keying (LSK) principle or technique is known and shown in FIG. 1. The information from the secondary coil of a data transformer is transmitted to the primary side by modulating the load of the secondary coil. This correspondingly changes the value of the reflected impedance Zᵣ in the primary coil.

Typically, the primary coil inductance resonates with the capacitor C₁ on the primary side and the inductance of the secondary coil resonates with the capacitor C₂ on the secondary side at the same operating frequency. In this way the best power transfer efficiency is ensured and a low impedance load is provided for the driving (power) amplifier. The reflected impedance Zᵣ is given by:

$${Z}_{r} = \frac{{ω}^{2} {k}^{2} {L}_{1} {L}_{2}}{{Z}_{2}} \qquad ( 1 )$$

wherein
L₁ is the inductance of the primary coil,
L₂ is the inductance of the secondary coil,
ω is the angular frequency,
k is the coupling coefficient and
Z₂ is the equivalent impedance seen by the secondary coil.

At the resonance frequency:

$${Z}_{2} = \frac{{L}_{2}}{( {R}_{L} ‖ {R}_{M} ) {C}_{2}} \qquad ( 2 )$$

and it is purely resistive. Substituting equation 2 into equation 1 gives:

Zᵣ=ω²k²L₁C₂(R_{L}∥R_{M}) (3)

wherein
R_{L} is the load resistance and
R_{M} is the modulating resistor.

The sensitivity with respect to R_{L}∥R_{M} is given by the first derivative:

Z′ᵣ=ω²k²L₁C₂ (4)

From equation 4 it can be seen that the sensitivity depends strongly on the coupling coefficient k. If the coils have a space separation of 4 to 5 cm, for example like in an implant, k has a quite low value. Usually ω, L₁ and C₂ are fixed by other design considerations. The only way to get a bigger change of Zᵣ is to increase the change of R_{L}∥R_{M} as much as possible:

delta(Zᵣ)=Z′ᵣdelta(R_{L}∥R_{M}) (5)

Since R_{L} is a known load resistance representing a whole circuit, the modulating resistor R_{M} has to be as small as possible resulting in a significant power loss, basically burning all the power available to the circuit due to the shunting.

In practice, it is very likely that the load circuit represented by R_{L} has to be supplied by a DC voltage provided by a rectifier BR₁ resulting in the topology shown in FIG. 2.

The present invention introduces a topology that improves the power efficiency and the sensitivity of the Load-Shift Keying technique. At relatively large distances (e.g. 4 to 5 cm) between the transformer coils the coupling coefficient k has a low value resulting in a low sensitivity of the reflected impedance in the primary coil. A large change of the load impedance of the secondary coil is needed in order to obtain a sufficient change in the primary coil resulting in significant power loss.

The solutions according to the present invention effectively decouple the sensitivity from the associated power losses thus saving a lot of power in the implantable device and as a result in the whole system.

The solutions according to the present invention save a lot of power at fixed sensitivity or alternatively increase the sensitivity at fixed power consumption.

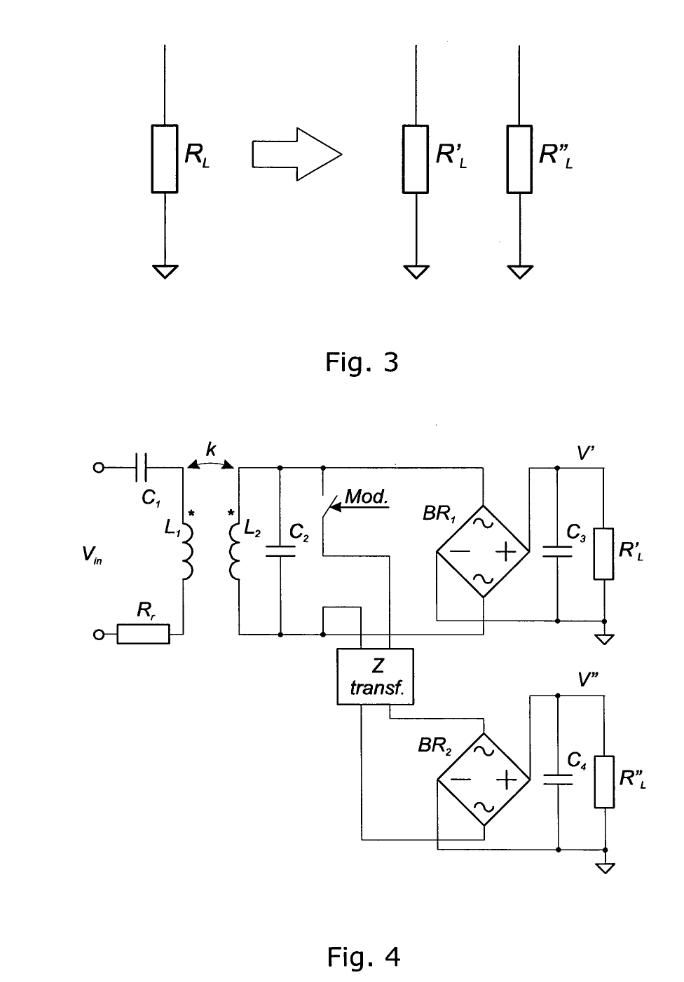

The solutions according to the present invention use the energy normally or usually lost or burned in the modulating resistor R_{M} (of modulating means Mod.) in such a way that it is transferred or directed to supply a part of the load circuit on the secondary side. This basically decouples the change of the reflected impedance Zᵣ from the associated power loss(es). In fact the load resistance R_{L} can be presented by many circuit blocks supplied in parallel. It can be decomposed into two load resistors R′_{L} and R″_{L} that represent two groups of building blocks of the load circuit as shown in FIG. 3.

FIG. 4 illustrates one possible embodiment according to the present invention comprising a first power efficient architecture employing the Load-Shift Keying technique or principle. One possible embodiment of a data transformer for wireless transmission of energy and/or data from the primary side to the secondary side and vice versa is shown in FIG. 4. By employing reactive impedance transformation with low loss, the energy usually lost or burned in the modulating resistor R_{M} is instead directed for powering another part of the load circuit on the secondary side.

In this case, R_{M} (not shown explicitly in FIG. 4) is simply the low input impedance of the impedance transform circuit Z transf. Its output impedance is high in order to increase the voltage level in the output. If this extra circuit is built of high quality factor components its loss can be very low.

The possible embodiment of the data transformer shown in FIG. 4 comprises on the primary side a primary coil L₁ which is connected to a primary capacitor C₁ resonating with the primary coil L₁ at an operating frequency, and on the secondary side a secondary coil L₂ which is connected to: a secondary capacitor C₂ resonating with the secondary coil L₂ at the same operating frequency; a load circuit R_{L}; and modulating means Mod. comprising a digital circuit with for example two input channels (e.g. one clock and one data input) and one output channel, a modulating switch receiving a modulating signal from the digital circuit output channel and a modulating resistor R_{M}, which modulating means is being used for modulating the load on the secondary side in order to get data transmitted to the primary side. The load circuit R_{L} is decomposed into at least two load circuits R′_{L} and R″_{L} representing at least two groups of building blocks of the whole load circuit R_{L}, wherein at least one R″_{L} of said at least two load circuits R′_{L} and R″_{L} is powered by the energy normally lost or burned in the modulating means Mod., and particularly in its modulating resistor R_{M}. The rest R′_{L} of said at least two load circuits R′₁, R″_{L} is powered by the secondary coil in a standard way.

The secondary capacitor C₂ can be connected in parallel with the secondary coil L₂.

In the resulting topology at least two rectifiers BR₁, BR₂ (e.g. bridge rectifiers or the like) can be used for supplying said at least two load circuits R′_{L}, R″_{L}. However, if they are integrated on a chip this is not an issue. It is also possible to have the whole system implemented on a chip.

The voltages V′ and V″ supplying the circuits R′_{L} and R″_{L} can be different. This is not a problem especially if differential topologies are used.

It is also possible to have a transformation impedance Z after the modulating means Mod. taken with respect from the secondary coil L₂, through the modulating means Mod. and towards the load circuit(s), which means that transformation impedance circuit Z is placed or used between the modulating means Mod. and this load circuit R″_{L} that is powered by the energy usually lost or burned in the modulating means Mod. In the case when a rectifier BR₂ is used for supplying the load circuit R″_{L} the impedance transformer Z can be between the modulating means Mod. and the rectifier BR₂.

The modulating switch changes the impedance on the secondary side in order to modulate the impedance on the primary side so that desired data can be transmitted from the secondary side to the primary side.

The primary side is usually supplied by an input voltage Vᵢₙ.

By reference Rᵣ the reflected resistance on the primary side is given, which resistance Rᵣ is a part of the reflected impedance Zᵣ.

Usually the change in the reflected resistance Rᵣ and/or the reflected impedance Zᵣ is being used by a demodulator or demodulating means (not shown) for signal demodulation on the primary side.

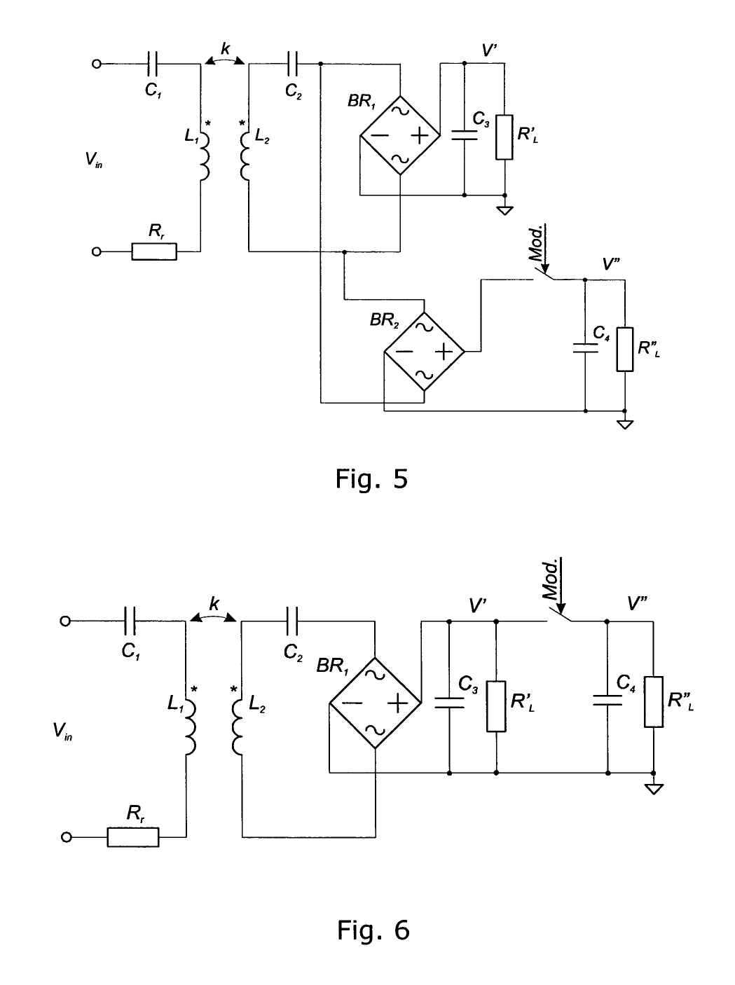

FIGS. 5 and 6 show different embodiments of the data transformer according the present invention, wherein the secondary coil L₂ is connected to the secondary capacitor C₂ in series.

In FIG. 5 the load circuits R′_{L} and R″_{L} are connected to separate rectifiers BR₁ and BR₂ correspondingly for supplying each of the load circuits R′_{L} and R″_{L}. The modulating means Mod. can be placed after the rectifier BR₂ used for supplying the load circuit R″_{L}, taken with respect from the secondary coil L₂ towards the second load circuit R″_{L}.

In FIG. 6 the load circuits R′_{L} and R″_{L} are connected in such a way that only one rectifier BR₁ is being used. The modulating means Mod. can be placed after the first load circuit R′_{L} and before the second load circuit R″_{L}, taken with respect from the secondary coil L₂ towards the second load circuit R″_{L}.

In parallel with the load circuits R′_{L}, R″_{L} (filtering and storage) capacitors C₃, C₄ can be connected.

The impedance of a capacitor C_{S} and a resistor Rₛ in series can be transformed to parallel impedance and/or vice versa:

$$C \approx {C}_{s} \approx {C}_{p} \\ {R}_{p} \approx \frac{1}{{{R}_{s} ( C ω )}^{2}} \qquad ( 6 )$$

wherein
ω is the angular frequency,
Cₚ is the capacitor in the parallel topology and
Rₚ is the resistor in the parallel topology.

One of the networks can be replaced with the other equivalently if the signal is narrowband and if the quality factor of the capacitor C is high.

The impedance transformation can be achieved by means of a capacitive divider which can be one possible choice for the Z transformation block, wherein said Z transformation block circuit comprises a capacitor C₁ coupled in series with parallel connected capacitor Cₚ and resistor Rₚ. The total resistance Rₜₒₜ of the Z transformation block will then be given by:

$${R}_{tot} \approx {( 1 + \frac{{C}_{p}}{{C}_{1}} )}^{2} {R}_{p} \qquad ( 7 )$$

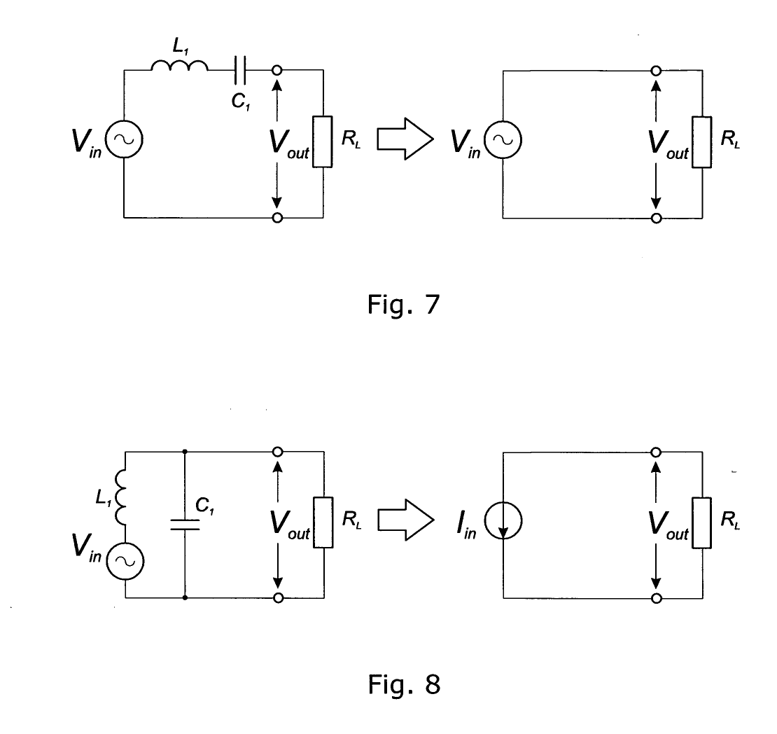

FIGS. 7-9 give some further explanations of the principles behind the invention.

The circuit in FIG. 7 is an ideal AC voltage source Vᵢₙ connected in series with a capacitor C₁, an inductor or inductance L₁ and a load resistor R_{L}. R_{L} is a linear resistor. The capacitor C₁ and the inductor L₁ form a series resonance (left side of FIG. 7). When the frequency of this resonance is the same as the frequency of the input voltage source Vᵢₙ the LC network is equal to short circuit. Under these conditions the load R_{L} is directly connected to the ideal voltage source Vᵢₙ, i.e. Vᵢₙ=Vₒᵤₜ (right side of FIG. 7). If the resistance of R_{L} changes, Vₒᵤₜ will remain constant. If the resistor R_{L} is non-linear the short circuit is only for the first harmonic of the current.

The circuit in FIG. 8 is also an ideal AC voltage source Vᵢₙ with an inductor or inductance L₁ connected in series. However, in this case the capacitor C₁ is connected in parallel to the already formed series network. A load resistor R_{L} is connected in parallel to the capacitor C₁ (left side of FIG. 8). L₁ and C₁ form a parallel resonance tank which has infinite impedance at the resonance frequency. If the frequency of the resonance is equal to the frequency of Vᵢₙ, the whole network can be considered as a current source Iᵢₙ connected directly to the load resistor R_{L} (right side of FIG. 8). In this case, if the resistance of R_{L} changes, Vₒᵤₜ will change proportionally.

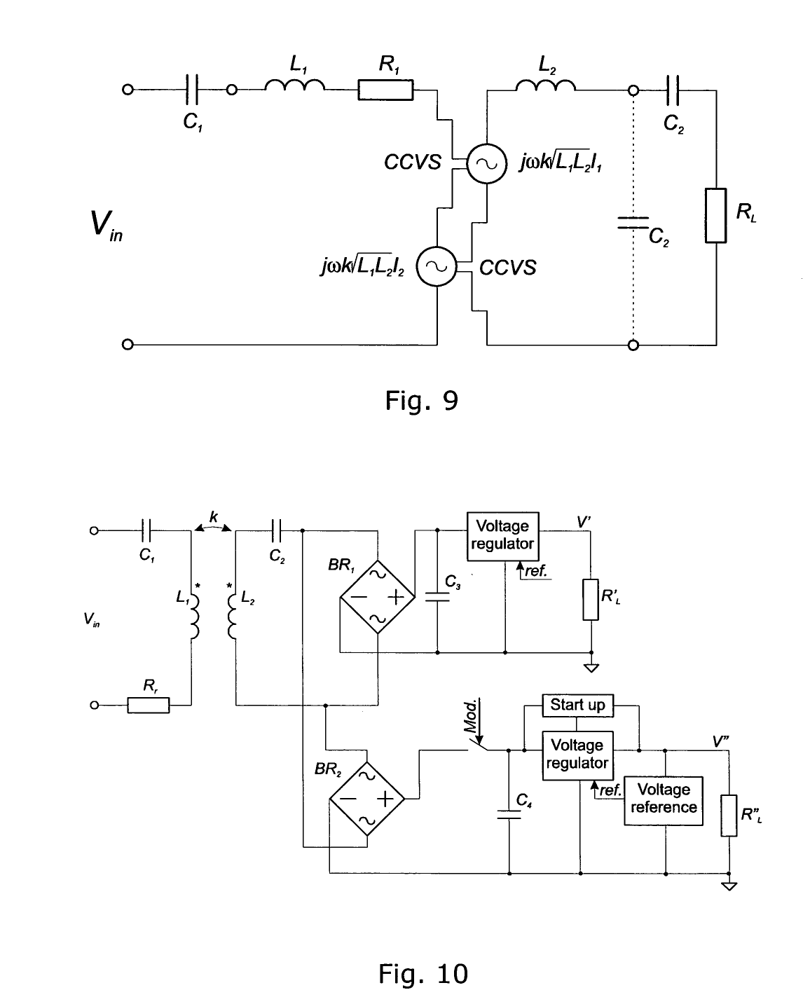

In FIG. 9 a well-known equivalent model of a transformer is presented, wherein a capacitor C₁ is resonating with the inductance of the primary coil L₁ and a capacitor C₂ is resonating with the inductance of the secondary coil L₂. The capacitor C₁ resonates with the primary coil L₁ in order to provide low input impedance for the transformer driving stage. It is obvious that the resonant capacitor C₂ can be connected in series or in parallel to the secondary coil L₂. In the first case, as shown in FIG. 7, the load R_{L} is powered by a voltage source. In the second case, analogous to FIG. 8, the load R_{L} is powered by a current source. The parasitic resistance of the secondary coil L₂ is not modelled for the sake of clarity.

Ideally, when R_{L} changes, the voltage across it should remain constant. This is why it is preferable to have C₂ connected in series with the secondary coil L₂. In this way the impedance transformation block Z needed in the parallel configuration of the Load-Shift Keying (LSK), shown in FIG. 4, to raise the voltage is not necessary in the series configuration, shown in FIG. 5.

In FIG. 10 a further developed embodiment of the one in FIG. 5 is shown. The main purpose of the voltage regulators is to maintain the voltages V′ and V″ constant while the modulating switch or means Mod. switches. When the modulating switch or means Mod. switches, the voltage across C₄ changes. The change depends on the value of C₄ and on the duty cycle and the frequency of the modulating signal from the modulating switch or means Mod. assuming that all the rest of the circuitry is fixed. For some values of C₄ as well as the duty cycle and the frequency of the modulating signal, the voltage change across the capacitors is small enough and a voltage regulator may not be necessary (as for example in FIG. 4-6).

When the modulating switch or means Mod. switches the voltage across C₃ will also change a little bit. This is because the secondary coil L₂ of the transformer is connected to a variable non-linear load. The resonance circuit L₂-C₂ is short only for the carrier frequency and not for the harmonics. The harmonics will form a voltage drop across L₂-C₂. If the load was linear (i.e. if there were no rectifiers BR₁, BR₂ and other non-linear components), the voltage across C₃ would remain almost constant. Again, the voltage change across C₃ depends also on the value of C₃ and on the duty cycle and the frequency of the modulating signal from the modulating switch or means Mod. The voltage reference block provides an accurate and temperature stable reference voltage. It is connected at the output of the voltage regulator because the voltage there has a lower ripple compared to the input. The “ref.” signal is the reference voltage signal. The voltage regulator compares the “ref.” signal with its output voltage and minimizes the difference (maintains the output voltage constant). The start up block is needed when the whole system is powered up. At that moment the “ref.” signal is zero and therefore the output of the regulator is zero. The start up circuit just provides supply voltage to the voltage reference block till the “ref.” signal reaches its predetermined value. After that the start up circuit does not affect the operation. If the voltage reference block is connected to the input of the regulator a start up circuit is not necessary.

The solutions according to the present invention provide for an improvement of the general Load Shift Keying (LSK) technique and can work with every data transformer.

The embodiments of the data transformer according the present invention can be used in a system where it is necessary to have wireless transmission of energy and/or data from the primary side to the secondary side and vice versa.

The modulating means, the data transformer and/or the system according to the present invention can be operated and/or controlled by a suitable software run by a processor.

The present invention concerns also a method for wireless transmission of energy and/or data from a first module to a second module and vice versa, comprising the following steps:
a load circuit R_{L} of the second module is being decomposed into at least two load circuits R′_{L}, R″_{L} (arranged in parallel) representing at least two groups of building blocks of the whole load circuit R_{L},
at least one R″_{L} of said at least two load circuits R′_{L}, R″_{L} is being powered by the energy normally lost or burned in modulating means Mod. on the secondary side (particularly in its modulating resistor R_{M}), said modulating means Mod. being used for the wireless transmission of energy and/or data, and
the rest R′_{L} of said at least two load circuits R′_{L}, R″_{L} is being powered in a standard way by the secondary coil of the second module.

When the two coils L₁ and L₂ are relatively close to each other they are in their respective near fields. In this case we have a transformer. When the same two coils are far from each other they are in their respective far fields. In this case we have two coil antennas. Other type of antennas (e.g. “dipole”, but not limited thereto) can also be used.

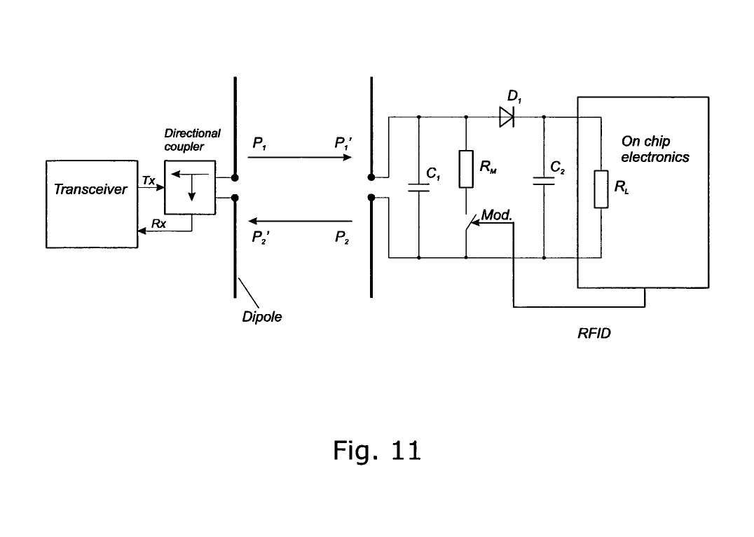

The power saving Load-Shift Keying (LSK) idea of the present invention is also applicable in the case of far field communication. In this case there is communication between two antennas. This is shown in FIG. 11. The load of the antenna changes according to the modulating signal of the modulating means Mod. The reflected power P₂ changes correspondingly. The power lost in the modulating resistor R_{M} (of the modulating means Mod.) can be instead directed to power the on-chip electronics. The RFID is entirely powered by the power received by the dipole antenna. The transceiver radiates power towards the RFID and receives the data from it. Tₓ is the transmitted signal of the transmitter, Rₓ is the received signal by the receiver. The directional coupler isolates the transmitting path of the transceiver from the receiving one because they share the same antenna. P₁ is the transmitted signal (power) by the first dipole antenna. P₁′ is the signal (power) that reaches the dipole of the RFID. P₂′ is the reflected power of the dipole of the RFID that reaches the transceiver antenna.

It is possible for instance to use the solutions according to the present invention in all medical implants that require sending data to and/or from outside and/or inside of the body, including but not limited to: pace makers, cochlear and retina implants, artificial joints, functional electrical stimulators for brain, spinal cord, diaphragm, bladder, vagus nerve, cacral nerve and so on.

Another possible application of the present invention is in the Radio Frequency Identification (RFID). RFIDs are used for supply chain management, access control to buildings, public transportation, open air events, airport baggage, express parcel logistics and many more.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second”, etc. do not preclude a plurality. Furthermore, reference signs in the claims shall not be construed as limiting the scope.

1. A data transformer for wireless transmission of energy or data from the primary side to the secondary side and vice versa, the data transformer comprising on the primary side a primary coil (L₁) connected to a primary capacitor (C₁) resonating with the primary coil (L₁) at an operating frequency, and on the secondary side a secondary coil (L₂) connected to a secondary capacitor (C₂) resonating with the secondary coil (L₂) at the same operating frequency, to modulating means (Mod.) for modulating the load on the secondary side in order to get data transmitted to the primary side, and to a load circuit (R_{L}), wherein:
the load circuit (R_{L}) is decomposed into at least two load circuits (R′_{L}, R″_{L}) in parallel representing at least two groups of building blocks of the whole load circuit (R_{L}), wherein the energy normally or usually lost or burned in the modulating means (Mod.) is instead directed for powering at least one (R″_{L}) of said at least two load circuits (R′_{L}, R″_{L}), while the rest (R′_{L}) of said at least two load circuits (R′_{L}, R″_{L}) is powered by the secondary coil in a standard way.

2-14. (canceled)

15. The data transformer according to claim 1, wherein the secondary capacitor (C₂) is connected in parallel with the secondary coil (L₂).

16. The data transformer according to claim 1, wherein the secondary capacitor (C₂) is connected in series with the secondary coil (L₂).

17. The data transformer according to claim 1, wherein said at least two load circuits (R′_{L}, R″_{L}) are connected in parallel.

18. The data transformer according to claim 1, wherein a transformation impedance circuit (Z) is used between the modulating means (Mod.) and said at least one load circuit (R″_{L}) that is powered by the energy usually lost or burned in the modulating means (Mod.).

19. The data transformer according to claim 1, wherein at least one rectifier (BR₁, BR₂) is used between said at least two load circuits (R′_{L}, R″_{L}) and the secondary coil (L₂).

20. The data transformer according to claim 1, wherein filtering capacitors (C₃, C₄) are connected in parallel with said at least two load circuits (R′_{L}, R″_{L}).

21. A system for wireless transmission of energy or data from a first module of the system to a second module of the system and vice versa, wherein the system comprises a data transformer according to claim 1.

22. The system according to claim 21, wherein the system is designed for biological signal sensing.

23. The system according to claim 21, wherein the system is a Radio Frequency Identification (RFID) system.

24. The system according to claim 22, wherein the first module of the system is an external module and the second module of the system is an implantable module.

25. The system according to claim 21, wherein the first and second coils of said data transformer are two antennas used in far field communication and wherein the first module of the system is a transceiver and the second module of the system is an RFID.

26. A method for wireless transmission of energy or data from a first module to a second module and vice versa comprising:
a load circuit (R_{L}) of the second module is being decomposed into at least two load circuits (R′_{L}, R″_{L}) in parallel representing at least two groups of building blocks of the whole load circuit (R_{L}),
the energy normally or usually lost or burned in modulating means (Mod.) on the secondary side is instead directed for powering at least one (R″_{L}) of said at least two load circuits (R′_{L}, R″_{L}), wherein the modulating means (Mod.) is used for the wireless transmission of energy or data, and
the rest (R′_{L}) of said at least two load circuits (R′_{L}, R″_{L}) is being powered in a standard way by the secondary coil of the second module.

27. A system comprising a transceiver and an RFID using the method of claim 26.
